(19) United States
(12) Patent Application Publication
(10) Pub. No.: US 2026/0019958 A1
(43) Pub. Date: Jan. 15, 2026

(54) SMART TX TO IMPROVE DOWNLINK PERFORMANCE IN UPLINK-LIMITED SCENARIO

(71) Applicant: QUALCOMM Incorporated, San Diego, CA (US)

(72) Inventor: Akash KUMAR, Hyderabad (IN)

(21) Appl. No.: 18/773,420

(22) Filed: Jul. 15, 2024

(51) Int. Cl. H04W 52/36; H04W 52/22; H04W 52/26

(52) U.S. Cl. CPC H04W 52/367; H04W 52/225; H04W 52/265

(57) ABSTRACT

An apparatus may be a wireless device or user equipment (UE) configured to obtain an indication of a limit for a power associated with uplink (UL) transmissions. The apparatus may transmit, at a first calculated power, a first UL transmission carrying information related to a downlink (DL) data transmission and transmit, with a second calculated power based on the limit, a second UL data transmission not carrying information related to the DL data transmission.

### TECHNICAL FIELD

The present disclosure relates generally to communication systems, and more particularly, to power control for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or user equipment (UE) configured to obtain an indication of a limit for a power associated with uplink (UL) transmissions. The apparatus may transmit, at a first calculated power, a first UL transmission carrying information related to a downlink (DL) data transmission and transmit, with a second calculated power based on the limit, a second UL data transmission not carrying information related to the DL data transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a set of related diagrams illustrating aspects of implementing differential power limitation for different types of UL transmissions in accordance with some aspects of the disclosure.

FIG. 5A is a diagram illustrating a UE including multiple that may be power-limited based on an energy measured at a volume in accordance with some aspects of the disclosure.

FIG. 5B is a diagram illustrating a set of power limits associated with the different antennas in accordance with some aspects of the disclosure.

FIG. 5C is a diagram illustrating a total energy exposure at the volume based on different power limits imposed on the plurality of antennas in accordance with some aspects of the disclosure.

FIG. 6 is a call flow diagram illustrating a method of wireless communication in accordance with some aspects of the disclosure.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

### DETAILED DESCRIPTION

In some aspects of wireless communication, there are multiple reasons that an UL transmission (or transmit) power from a UE may be subject to a limit. For example, a limit may be placed on UL transmission power (from a first radio and/or transceiver component) based on a proximity to another subsystem of the UE (e.g., proximity to a camera, microphone, or other subsystem), a specific absorption rate (SAR) limit based on a proximity to a human body and imposed by a regulatory body, additional radios and/or transceivers (e.g., a coexistence limit due to multi-radio coexistence in a dual sim dual active (DSDA) system or other multi-radio devices), a thermal-related limit, or based on other limitations and/or considerations. A limit placed on the UL transmission power may be associated with, or lead to, a high (or increased) UL block error rate (BLER) and/or a lower power headroom value being reported in a power headroom report (PHR). In some aspects, these effects may compound and eventually lead to a network throttling a UL grant and/or resource allocation to reach an outer loop link adaptation (OLLA) target BLER. Accordingly, when a limit is imposed on the UL transmission power, the UE's UL performance may be limited. In some aspects, the limited performance limitation may be justified by the safety and/or reliability concerns leading to the imposition of the UL transmission power limit.

While the effects on the UL data transmission may be unavoidable based on the imposed limit on the UL transmission power, in some aspects, the DL performance may be unnecessarily affected. For example, when the UL transmission power is limited, a sounding reference signal (SRS) antenna switching transmission may be compromised (e.g., may indicate a weaker channel/link for DL communication than exists) leading to inferior DL allocation (Rank, Resources, etc.). Additionally, or alternatively, in far cell scenarios, acknowledgments (ACKs) and/or negative ACKs (NACKs) over a physical UL control channel (PUCCH) may be impacted, for example, they may not be received at a target device (e.g., a wireless device transmitting a DL transmission associated with the ACK/NACK) when the transmit power limit is significantly lower than a transmit power that would otherwise be used in the absence of the limitation. In some aspects, UL transmissions containing DL CSI reports may also be impacted. In some aspects, the UL transmission power limit may be based on an average power over a defined time window and/or duration (e.g., may be an average UL transmission power over the time window and/or duration) and the transmissions carrying DL related control information (e.g., the SRS, the ACKs/NACKs, the DL CSI reports, etc.) may be short, very sparse (in frequency), and infrequent. Accordingly, an UL transmission (or transmit) power greater than the imposed UL transmission power limit may be used for the UL transmissions carrying the DL related control information without exceeding the imposed UL transmission power limit when averaged over the time window and/or duration.

Various aspects relate generally to enhancements that can be integrated to a transmission power framework taking into account the type of information sent over UL transmissions. Some aspects more specifically relate to UL transmissions that are related to DL (and/or DL control) being treated differently in order to protect DL performance in these UL transmission power limited cases. In some examples, a wireless device (e.g., a UE) may be configured to obtain an indication of a limit for a power associated with a set of UL transmissions, transmit, at a first calculated power, a first UL transmission carrying information related to a DL data transmission, and transmit, at a second calculated power based on the limit, a second UL data transmission not carrying the information related to the DL data transmission.

Particular aspects of the subject matter described in this disclosure can be implemented to realize one or more of the following potential advantages. In some examples, by treating UL transmissions that are related to DL (and/or DL control) being differently than UL transmissions unrelated to DL (and/or DL control) the described techniques can be used to protect DL performance in the presence of UL transmission power limiting.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

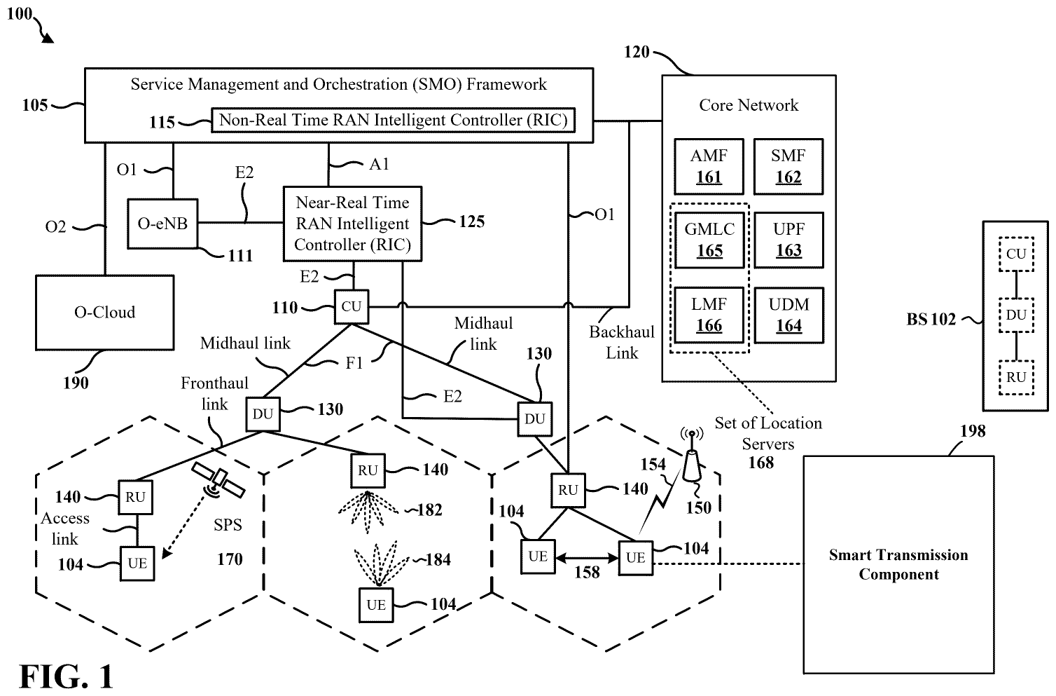

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a smart transmission component 198 that may be configured to obtain an indication of a limit for a power associated with UL transmissions, transmit, at a first calculated power not based on the indicated limit, a first UL transmission carrying information related to a DL data transmission, and transmit, with a second calculated power based on the indicated limit, a second UL data transmission not carrying information related to the DL data transmission. Although the following description may be focused on 5G NR, the concepts described herein may be applicable to other similar areas, such as LTE, LTE-A, CDMA, GSM, and other wireless technologies.

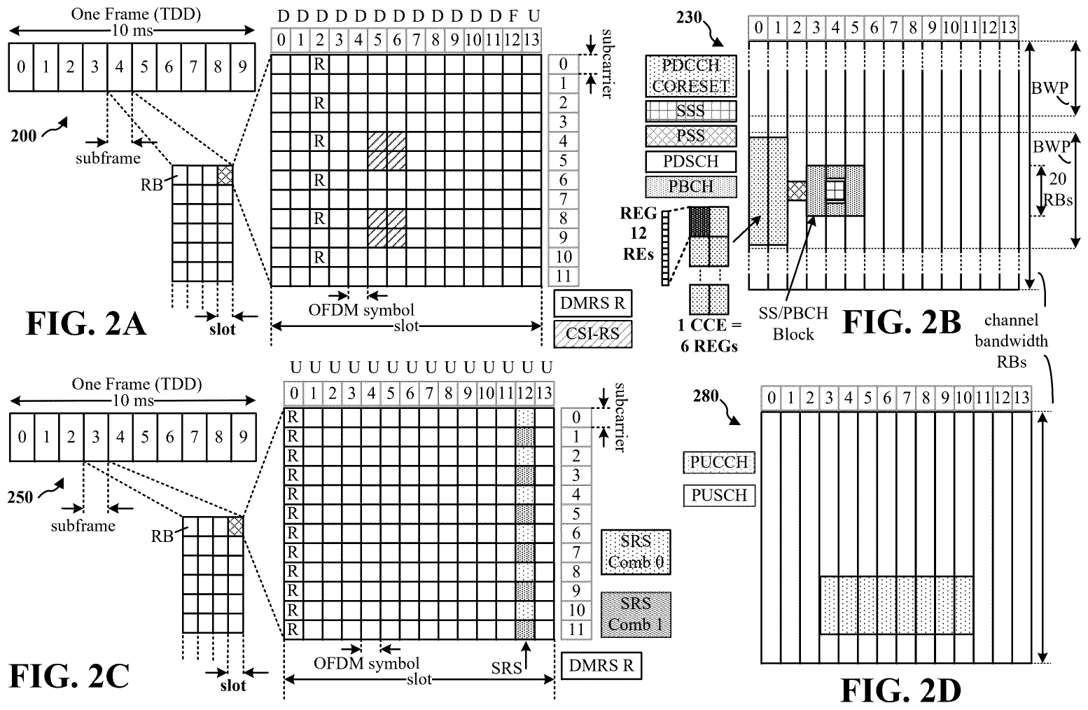

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2″*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

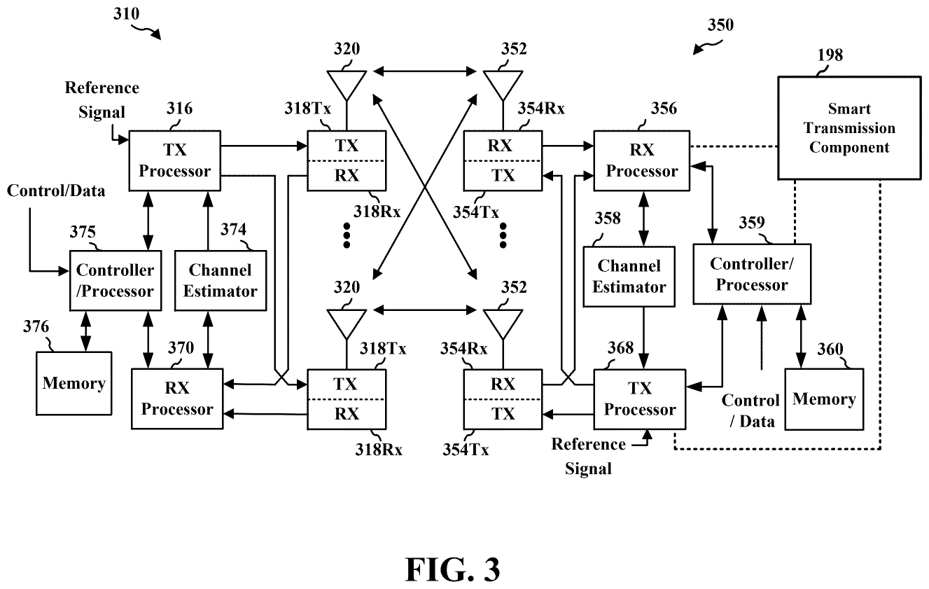

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the smart transmission component 198 of FIG. 1.

In some aspects of wireless communication, there are multiple reasons that an UL transmission (or transmit) power from a UE may be subject to a limit. For example, a limit may be placed on UL transmission power (from a first radio and/or transceiver component) based on a proximity to another subsystem of the UE (e.g., proximity to a camera, microphone, or other subsystem), a SAR limit based on a proximity to a human body and imposed by a regulatory body, additional radios and/or transceivers (e.g., a coexistence limit due to multi-radio coexistence in a DSDA system or other multi-radio devices), a thermal-related limit, or based on other limitations and/or considerations. A limit placed on the UL transmission power may be associated with, or lead to, a high (or increased) UL BLER and/or a lower power headroom value being reported in a PHR. In some aspects, these effects may compound and eventually lead to a network throttling a UL grant and/or resource allocation to reach an OLLA target BLER. Accordingly, when a limit is imposed on the UL transmission power, the UE's UL performance may be limited. In some aspects, the limited performance limitation may be justified by the safety and/or reliability concerns leading to the imposition of the UL transmission power limit.

While the effects on the UL data transmission may be unavoidable based on the imposed limit on the UL transmission power, in some aspects, the DL performance may be unnecessarily affected. For example, when the UL transmission power is limited, an SRS antenna switching transmission may be compromised (e.g., may indicate a weaker channel/link for DL communication than exists) leading to inferior DL allocation (Rank, Resources, etc.). Additionally, or alternatively, in far cell scenarios, ACKs and/or NACKs over a PUCCH may be impacted, for example, they may not be received at a target device (e.g., a wireless device transmitting a DL transmission associated with the ACK/NACK) when the transmit power limit is significantly lower than a transmit power that would otherwise be used in the absence of the limitation. In some aspects, UL transmissions containing DL CSI reports may also be impacted. In some aspects, the UL transmission power limit may be based on an average power over a defined time window and/or duration (e.g., may be an average UL transmission power over the time window and/or duration) and the transmissions carrying DL related control information (e.g., the SRS, the ACKs/NACKs, the DL CSI reports, etc.) may be short, very sparse (in frequency), and infrequent. Accordingly, an UL transmission (or transmit) power greater than the imposed UL transmission power limit may be used for the UL transmissions carrying the DL related control information without exceeding the imposed UL transmission power limit when averaged over the time window and/or duration.

Various aspects relate generally to enhancements that can be integrated to a transmission power framework taking into account the type of information sent over UL transmissions. Some aspects more specifically relate to UL transmissions that are related to DL (and/or DL control) being treated differently in order to protect DL performance in these UL transmission power limited cases. In some examples, a wireless device (e.g., a UE) may be configured to obtain an indication of a limit for a power associated with a set of UL transmissions, transmit, at a first calculated power, a first UL transmission carrying information related to a DL data transmission, and transmit, at a second calculated power based on the limit, a second UL data transmission not carrying the information related to the DL data transmission.

Particular aspects of the subject matter described in this disclosure can be implemented to realize one or more of the following potential advantages. In some examples, by treating UL transmissions that are related to DL (and/or DL control) being differently than UL transmissions unrelated to DL (and/or DL control) the described techniques can be used to protect DL performance in the presence of UL transmission power limiting.

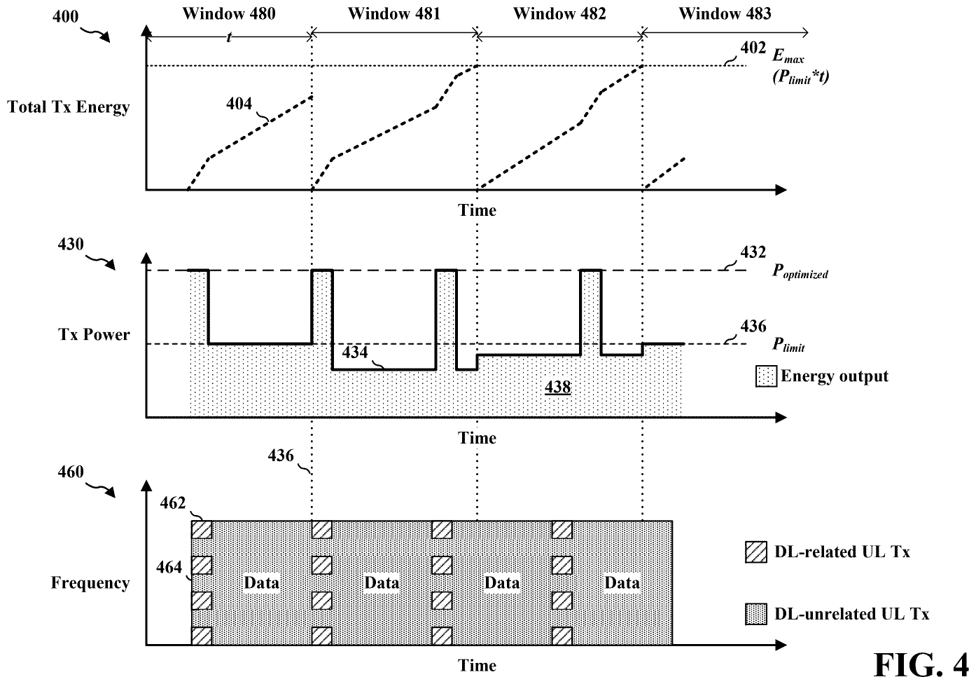

FIG. 4 is a set of related diagrams (e.g., diagram 400, diagram 430, and diagram 460) illustrating aspects of implementing differential power limitation for different types of UL transmissions in accordance with some aspects of the disclosure. Diagram 460 illustrates different sets of UL resources including a first set of resources 462 for (or associated with) DL-related UL transmissions (e.g., SRS transmissions, ACKs/NACKs, CSI, PUCCH transmissions, etc.) and a second set of resources 464 for (or associated with) UL transmissions unrelated to a DL data transmission (e.g., UL data transmissions).

Diagram 430 illustrates an UL transmission power over time associated with the different sets of UL resources illustrated in diagram 460. Diagram 430 illustrates a first transmission power 432 (P optimized) that may represent a power optimized (without consideration of any imposed power limits) to balance power consumption and accurate reception at a receiving device and a second power 436 (Pₗᵢₘᵢₜ) that may represent, or be based on, an imposed limit on (average) power based on, e.g., a coexistence with other components of a UE, exposure limits imposed by a regulatory body, or any other reason determined to maintain the energy output below the maximum and/or optimized energy output. In some aspects, the limit of the energy output may be associated with a time window (e.g., of duration t) such as one of window 480, window 481, window 482, and window 483 (e.g., the energy output limit may be imposed on an average basis over a configured and/or known amount of time). The second power 436 (Pₗᵢₘᵢₜ), in some aspects, may be further based on an expected volume of DL-related UL transmissions (e.g., if a large number of DL-related UL transmissions, or a large amount of DL-related UL data are expected) such that the total power is likely to be exceeded in the absence of further reductions of the second power 436 associated with other UL transmissions below an imposed power limit. In some aspects, the first transmission power 432 may also, or alternatively, be reduced (e.g., while still exceeding an imposed limit) based on the expected volume of DL-related UL transmissions so as to not exceed the average power limit (or the associated total energy output within a time window).

Diagram 430 further illustrates a transmission power 434 (or transmit power) associated with the resources and/or UL transmissions illustrated in diagram 460. In some aspects, the transmission power 434 for DL-related UL transmissions may be undiminished (or slightly diminished) after a limit is imposed when compared with a time before the limit is imposed or when compared with a power computed and/or determined independently from the limit. Based on the size and/or sparsity of the DL-related UL transmissions, in some aspects, the energy output over a time window may be below the limit even when the DL-related transmissions are transmitted at (or near) the first transmission power 432. Diagram 430 also depicts an energy output 438.

Diagram 400 illustrates a total and/or accumulated energy output 404 within a time window. In some aspects, an energy budget 402 (e.g., Eₘₐₓ) for the window (e.g., a maximum energy per unit of time defined by the window or a power headroom) may be allocated between DL-related (or DL-control-related) UL transmissions and UL transmissions unrelated to DL such that the DL-related UL transmissions are transmitted at, or near, a power optimized for reception at a receiving device while the UL transmissions unrelated to DL are transmitted a power based on the limit and/or a remaining energy budget. Accordingly, in a first time window, e.g., window 480, including transmissions over a portion (but not all) of the first time window, the DL-related UL transmissions may be transmitted at the first transmission power 432 and the UL transmissions unrelated to the DL may be transmitted at the second power 436 without exceeding the energy budget 402. During a second time window, e.g., window 481, the DL-related UL transmissions may be transmitted at the first transmission power 432, but, because there are two instances of the DL-related UL transmissions and there are UL transmissions scheduled and/or transmitted throughout the second time window, the UL transmissions unrelated to the DL may be transmitted at a power below the second power 436 based on the remaining energy budget after considering the DL-related UL transmissions. As a final example, during the third time window, e.g., window 482, the DL-related UL transmissions may be transmitted at the first transmission power 432, but, because there are UL transmissions scheduled and/or transmitted throughout the second time window, the UL transmissions unrelated to the DL may be transmitted at a power below the second power 436 (but above the power used during the second time window to transmit the UL transmissions unrelated to the DL) based on the remaining energy budget after considering the DL-related UL transmissions. In some aspects, the first power, may represent a slightly decreased power from an optimized power (e.g., a transmission power calculated and/or identified based on channel conditions, etc., without consideration of the imposed limit) to meet the energy budget. The amount of the decrease in the transmission power in some aspects may be based on a function of a PUCCH configuration and/or schedule. While the above discussion assumes that the DL-related UL transmissions may materially affect the total energy budget for the remaining UL transmissions, in some aspects, they may be so sparse in time and/or frequency that they may be transmitted at the optimized (or unlimited) power and the other UL transmissions may be transmitted at the imposed power limit without exceeding the total energy output over a time window such that no explicit calculation of remaining energy budget is made when imposing the limit on the other UL transmissions.

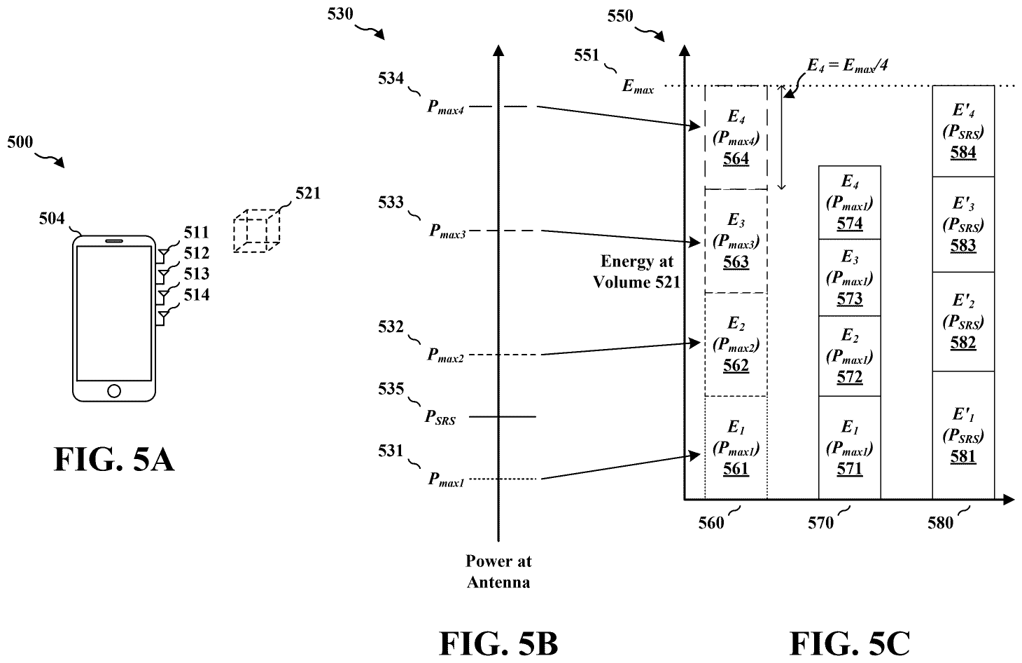

FIG. 5A is a diagram 500 illustrating a UE 504 including multiple antennas (e.g., first antenna 511, second antenna 512, third antenna 513, and fourth antenna 514) that may be power-limited based on an energy measured at a volume 521 in accordance with some aspects of the disclosure. As illustrated the antennas 511-514 may be located at different distances from the volume 521 and may therefore be associated with different power limits based on an exposure limit within the volume 521 (e.g., a maximum energy experienced within the volume 521 based on a transmission from the antenna at the power limit).

FIG. 5B is a diagram 530 illustrating a set of power limits associated with the different antennas in accordance with some aspects of the disclosure. As opposed to an aspect in which an imposed limit is largely ignored for DL-related UL transmissions across the plurality of antennas, in some aspects, limits may be imposed on a transmission power from the plurality of antennas. In some aspects, a power limit associated with the exposure limit may be determined and/or calculated for each antenna independently such that antennas farther from the volume 521 are associated with a higher power limit and antennas closer to the volume 521 are associated with a lower power limit. For example, a total exposure limit 551 (Eₘₐₓ) may be divided by the number of antennas in the plurality of antennas (or a number of antennas configured for simultaneous transmission) and a power limit for each antenna may be calculated based on the component of the total exposure limit (e.g., here, Eₘₐₓ/4) associated with the antenna based on the geometry, position, and/or location of the antenna. Accordingly, a first power limit 531 (Pₘₐₓ₁) may be associated with the first antenna 511, a second power limit 532 (Pₘₐₓ₂) may be associated with the second antenna 512, a third power limit 533 (Pₘₐₓ₃) may be associated with the third antenna 513, and a fourth power limit 534 (Pₘₐₓ₄) may be associated with the fourth antenna 514.

In some aspects, a set of SRS transmitted by a plurality of antennas may be assumed, constrained, and/or configured to be transmitted with a same power from each of the plurality of antennas. The power limits calculated under the assumption, or possibility, of independent transmission power from each antenna may thus be inappropriate and/or unnecessarily, or overly, restrictive. For example, in some aspects, applying the independently-calculated power limits leads to the plurality of antennas using the lowest power limit (e.g., the first power limit 531, Pₘₐₓ₁) which may be associated with an exposure and/or energy within the volume 521 that is significantly below the exposure limit. In some aspects, based on each antenna transmitting the SRS at a same power, a power limit 535 (e.g., P_{SRS}) greater than the minimum power (e.g., the first power limit 531, Pₘₐₓ₁) based on the total exposure limit 551 may be used for the SRS transmission such that the total exposure limit 551 is not exceeded.

FIG. 5C is a diagram 550 illustrating a total energy exposure at the volume 521 based on different power limits imposed on the plurality of antennas in accordance with some aspects of the disclosure. Diagram 550 illustrates that for a first scenario 560 with each antenna transmitting at the independently calculated power limit, the total exposure within the volume 521 is at or below the total exposure limit 551 (Eₘₐₓ) based on a first energy 561 (E₁) associated with the first antenna 511, a second energy 562 (E₂) associated with the second antenna 512, a third energy 563 (E₃) associated with the third antenna 513, and a fourth energy 564 (E₄) associated with the fourth antenna 514. For a second scenario 570 with each antenna transmitting at the power limit calculated for the first antenna 511 (e.g., the first power limit 531, Pₘₐₓ₁), the total exposure within the volume 521 is significantly below the total exposure limit 551. For example, the total exposure within the volume 521 in the second scenario 570 may be based on a first energy 571 (E″1) associated with the first antenna 511, a second energy 572 (E″2) associated with the second antenna 512, a third energy 573 (E″3) associated with the third antenna 513, and a fourth energy 574 (E″4) associated with the fourth antenna 514. The reduced power may lead to reduced signal quality and/or poorer reception at a receiving device. For example, the signal to noise ratio (SNR) of the SRS transmissions may be unnecessarily impacted and/or reduced. For a third scenario 580 with each antenna transmitting at a power limit calculated based on a common transmission power across the plurality of antennas, the total exposure within the volume 521 is at (or near, without exceeding) the total exposure limit 551 without unnecessary reduction of the transmission power and/or associated characteristics (e.g., a characteristic at the receiving device such as the SNR, a reference signal received power (RSRP), a RS received quality (RSRQ), or other signal power and/or quality metric). For example, the total exposure within the volume 521 in the third scenario 580 may be based on a first energy 581 (E′₁) associated with the first antenna 511, a second energy 582 (E′₂) associated with the second antenna 512, a third energy 583 (E′₃) associated with the third antenna 513, and a fourth energy 584 (E′₄) associated with the fourth antenna 514.

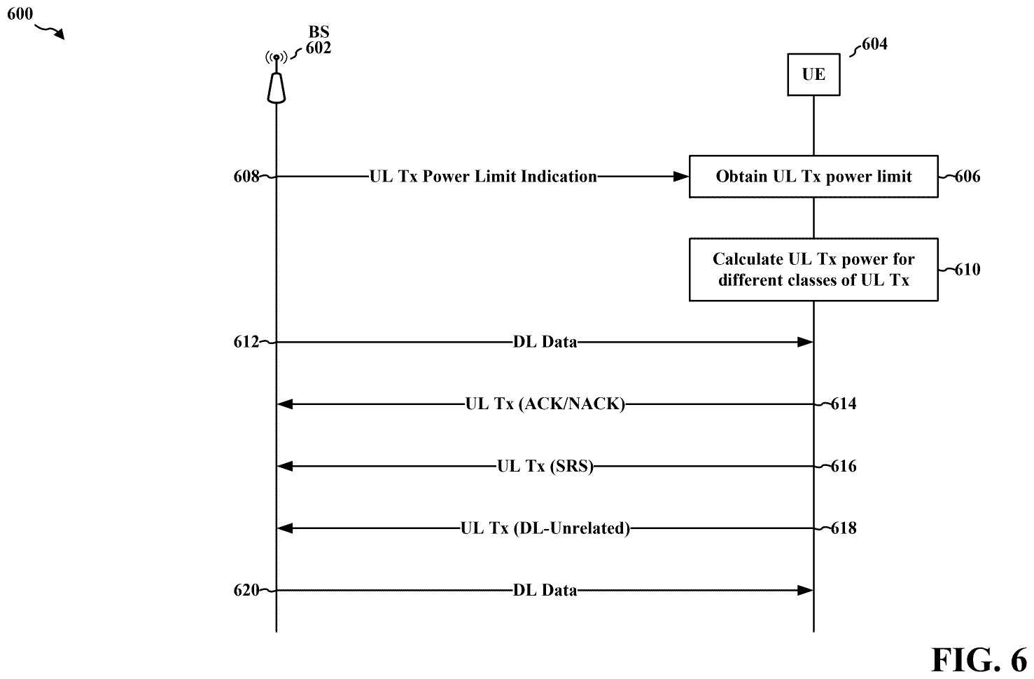

FIG. 6 is a call flow diagram 600 illustrating a method of wireless communication in accordance with some aspects of the disclosure. The method is illustrated in relation to a base station 602 (e.g., as an example of a network device or network node that may include one or more components of a disaggregated base station) in communication with a UE 604 (e.g., as an example of a wireless device). The functions ascribed to the base station 602, in some aspects, may be performed by one or more components of a network entity, a network node, or a network device (a single network entity/node/device or a disaggregated network entity/node/device as described above in relation to FIG. 1). Similarly, the functions ascribed to the UE 604, in some aspects, may be performed by one or more components of a wireless device supporting communication with a network entity/node/device. Accordingly, references to “transmitting” in the description below may be understood to refer to a first component of the base station 602 (or the UE 604) outputting (or providing) an indication of the content of the transmission to be transmitted by a different component of the base station 602 (or the UE 604). Similarly, references to “receiving” in the description below may be understood to refer to a first component of the base station 602 (or the UE 604) receiving a transmitted signal and outputting (or providing) the received signal (or information based on the received signal) to a different component of the base station 602 (or the UE 604).

The UE 604, in some aspects, may, at 606, obtain an indication of a limit for a power associated with a set of UL transmissions (e.g., an UL transmission power limit). In some aspects, the indicated UL transmission power limit obtained at 606 may be interpreted and/or expressed as an average power limit as described in relation to FIGS. 4 and 5A-C. The indicated UL transmission power limit may be a configured or known power limit based on a geometry, location, and/or position of one or more antennas and one or more of a coexisting component (e.g., a camera, microphone or other subsystem) and exposure limits (e.g., imposed by a regulatory agency). In some aspects, to obtain the indication of an UL transmission power limit at 606, the base station 602 may transmit, and the UE 604 may receive, an indication of an UL transmission power limitation 608.

Based on the UL transmission power limit obtained at 606 and/or based on characteristics of the communication between the UE 604 and the base station 602, the UE 604 may, at 610, calculate an UL transmission power for at least a first UL transmission in a first class of UL transmissions carrying information related to a DL data transmission (e.g., DL-related, or DL-control-related, UL transmissions such as ACKs/NACKs, SRS, CSI, and/or PUCCH transmissions or other transmissions related to channel quality or link quality) and a second UL transmission in a second class of UL transmissions not carrying the information related to the DL data transmission. In some aspects, a first UL transmission power calculated for the first class of UL transmissions at 610 may be independent of, or not based on, the indicated UL transmission power limit. The first UL transmission power calculated for the first class of UL transmissions at 610, in some aspects, may exceed the indicated UL transmission power limit (e.g., even when the first calculated power is based on the indicated UL transmission power limit). For example, if the first class of UL transmissions includes a small amount of DL-related data and/or sparse DL-related transmissions throughout a relevant time window, the first UL transmission power calculated for the first class of UL transmissions may be unrelated to, independent of, or not based on, the indicated UL transmission power limit, while for an amount of DL-related data and/or a density of DL-related transmissions that are above a threshold, the first UL transmission power calculated for the first class of UL transmissions may be based on the indicated UL transmission power limit.

In some aspects, a second UL transmission power calculated for the second class of UL transmissions not carrying the information related to the DL data transmission at 610 may be based on the indicated UL transmission power limit. For example, if the power and/or energy associated with the first class of UL transmissions is expected to be negligible and/or to not cause the transmissions of the second class of UL transmissions to exceed the average power (the total energy limit associated with the indicated UL transmission power limit), the second UL transmission power calculated for the second class of UL transmissions may be the indicated UL transmission power limit. Alternatively, if the power and/or energy associated with the first class of UL transmissions is expected to not be negligible, the second UL transmission power calculated at 610 may be less than the indicated UL transmission power limit by an amount that allows the first class of UL transmissions to be transmitted with a power that is greater than the indicated UL transmission power limit. For example, the second calculated power may be based on an amount of power remaining before exceeding the indicated limit after accounting for the transmission of at least the first UL transmission and/or additional UL transmissions in the first class of UL transmissions at the first calculated power during a particular time window.

The UE 604, in some aspects, may be associated with a plurality of antennas. In some aspects, the indicated UL transmission power limit obtained at 606 may include an indicated UL transmission power limit for each antenna as described in relation to FIGS. 5A-C. For example, the indicated UL transmission power limit obtained at 606 may include a first limit for a first power associated with a first antenna of the plurality of antennas and a second limit for a second power associated with a second antenna of the plurality of antennas, where the second limit may be lower than the first limit. The calculation at 610, in some aspects, may include calculating a power limit for each antenna and/or for the antennas as a group as described in relation to FIGS. 5A-C. Specifically, the calculation at 610, in some aspects, may include calculating a third calculated power for transmitting related reference signals (e.g., the SRS discussed in relation to FIGS. 5A-C) from each of the plurality of antennas. The third calculated power, in some aspects, may be greater than the second limit and less than the first limit. In some aspects, the calculation of the third power may not be separately performed, e.g., when the reference signals are considered to be in the first class of UL transmissions such that they are transmitted at the (first) power calculated for the first class of UL transmissions.

The base station 602 may transmit, and the UE 604 may receive, DL data 612 (or another DL transmission triggering a DL-related UL transmission such as an indication to transmit a CSI report). The UE 604 may transmit, and the base station 602 may receive, a first DL-related UL transmission 614 (e.g., an ACK/NACK in response to the DL data 612 or a CSI report) at the first UL transmission power calculated for the first class of UL transmissions. The UE 604 may further transmit, and the base station 602 may receive, one or more SRS 616 from one or more antennas of the UE 604. The one or more SRS, in some aspects, may be transmitted at one of the first UL transmission power calculated at 610 for the first class of UL transmissions or at the third UL transmission power calculated for the SRS transmitted by the one or more antennas. The first DL-related UL transmission 614 and/or the one or more SRS 616, in some aspects, may be referred to as DL-related UL transmissions and may both belong to the first class of UL transmissions. The UE 604 may transmit, and the base station 602 may receive, UL transmission 618 (e.g., an UL data transmission or other UL transmission unrelated to the DL transmission performance). The UL transmission 618 may be transmitted at the second UL transmission power calculated, at 610, for the second class of UL transmissions. Based on the DL-related UL transmissions, the base station 602 may transmit, and the UE 604 may receive, an additional DL transmission 620.

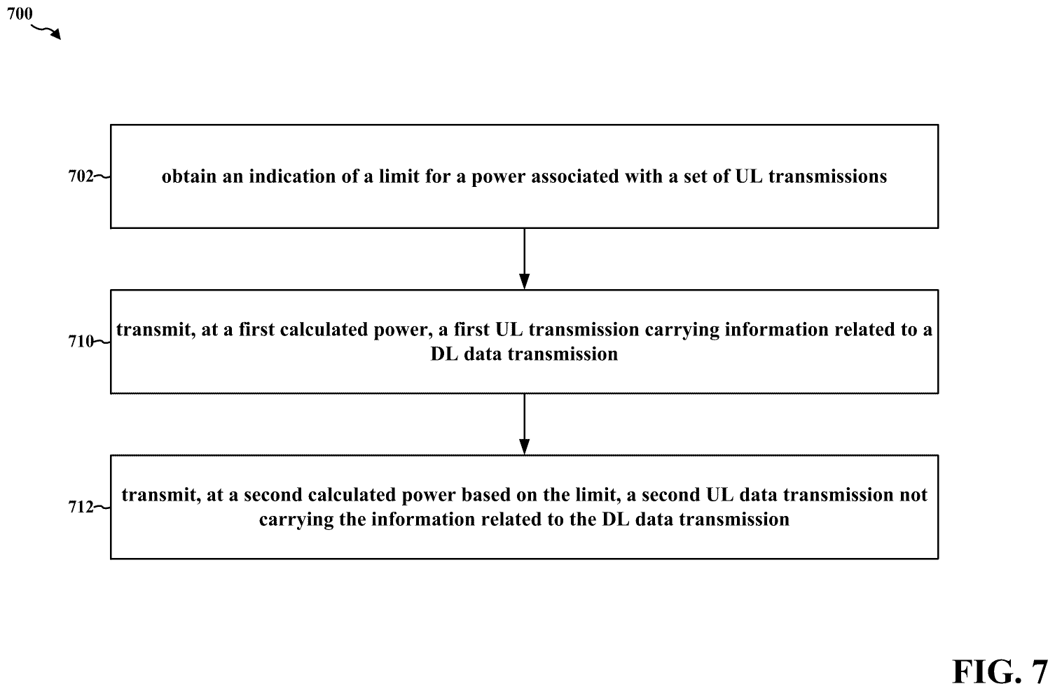

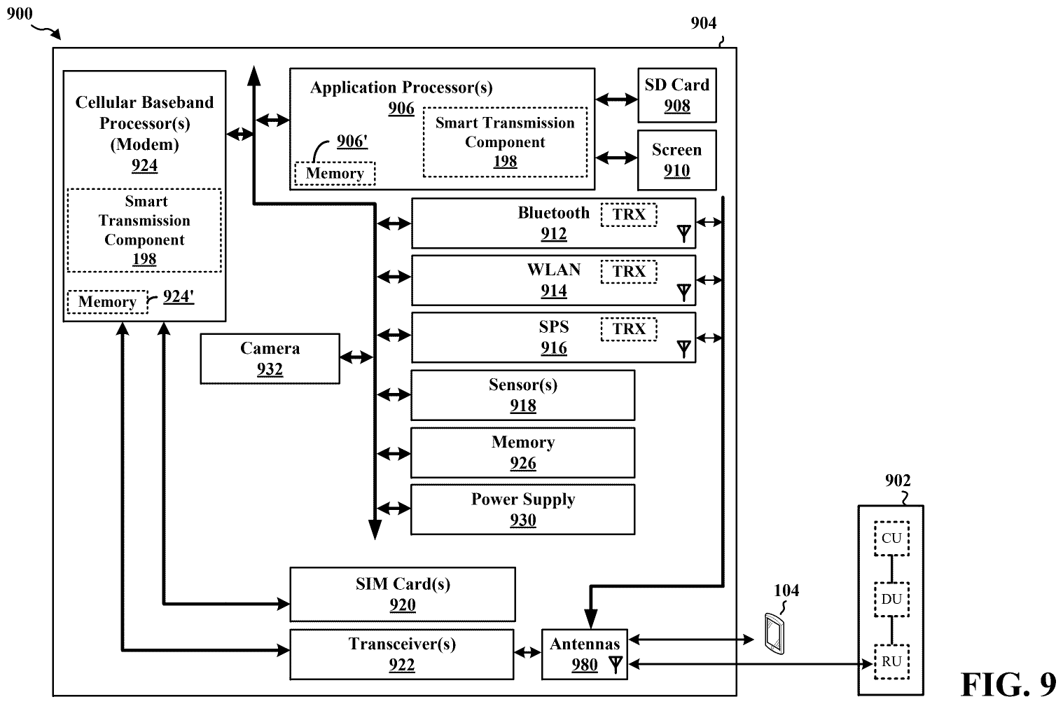

FIG. 7 is a flowchart 700 of a method of wireless communication. The method may be performed by a UE (e.g., the UE 104, 504, 604; the apparatus 904). At 702, the UE may obtain an indication of a limit for a power associated with a set of UL transmissions. In some aspects, the power associated with the set of UL transmissions may be an average power associated with a first duration. For example, 702 may be performed by application processor(s) 906, cellular baseband processor(s) 924, transceiver(s) 922, antenna(s) 980, and/or the smart transmission component 198 of FIG. 9. In some aspects, the indication may be an indication received from a base station or a known power limit based on the location and orientation of a set of antennas of the UE and a known set of limits based on additional components of the UE and/or exposure limits. The exposure limits, in some aspects, may be based on an SAR and imposed by a regulatory agency. For example, referring to FIG. 6, the UE 604 may obtain an indication of a power limit for UL transmissions at 606, that may be a known and/or configured power limit or the indication of an UL transmission power limitation 608.

In some aspects, the UE may calculate a first calculated power for at least a first UL transmission in a first class of UL transmissions carrying information related to a DL data transmission. In some aspects, the information related to the DL data transmission may be associated with at least one of a channel quality or a link quality. The first class of UL transmissions, in some aspects, may include one or more of ACKs in response to DL transmissions, NACKs in response to the DL transmissions, a RS transmission (e.g., an SRS) associated with the DL transmissions, information (e.g., CSI) regarding a channel between the UE and a source of the DL transmissions (e.g., a base station), and PUCCH transmissions. The first calculated power in some aspects, may be independent of, or may be based on, the UL transmission power limit. The first calculated power, in some aspects, may be greater than, or exceed, the UL transmission power limit. For example, referring to FIG. 6, the UE 604 may calculate, at 610, a first UL transmission power for at least a first UL transmission in a first class of UL transmissions carrying information related to a DL data transmission that may be independent of the indicated UL transmission power limit or may be based on, but greater than, the indicated UL transmission power limit.

The UE, in some aspects, may calculate a second limit for the power associated with a set of UL transmissions (e.g., at least a second UL transmission) in a second class of UL transmissions that is lower than the indicated limit. In some aspects, the second class of UL transmissions may include UL transmissions unrelated to DL transmission performance. The first class of UL transmissions, in some aspects, may be distinct from the second class of UL transmissions. In some aspects, the second limit may be calculated based on a power associated with UL transmissions in the first class of UL transmissions. The second calculated power, in some aspects, may be based on the first calculated power. For example, the second calculated power may be based on an amount of power remaining before exceeding the indicated limit after the transmission of the first UL transmission at the first calculated power The first class of UL transmissions, in some aspects, may include one or more of ACKs in response to DL transmissions, NACKs in response to the DL transmissions, a RS transmission (e.g., an SRS) associated with the DL transmissions, information (e.g., CSI) regarding a channel between the UE and a source of the DL transmissions (e.g., a base station), and PUCCH transmissions. For example, referring to FIGS. 4 and 6, the UE 604 may calculate, at 610, a second UL transmission power for at least a second UL transmission in a second class of UL transmissions not carrying the information related to the DL data transmission that may be based on the indicated UL transmission power limit as described for the UL data associated with the second set of resources 464.

In some aspects, the UE may calculate a third calculated power associated with a plurality of antennas for transmission of reference signals. In some aspects, the UE may include a plurality of antennas and the indicated limit may include a first limit for a first power associated with a first antenna of the plurality of antennas and a second limit for a second power associated with a second antenna of the plurality of antennas. The second limit, in some aspects, may be lower than the first limit. The reference signals, in some aspects, may be a set of SRS configured to be transmitted at a same power from each of the plurality of antennas. For example, referring to FIGS. 5A-C and 6, the UE 604 may calculate, at 610, a third calculated power for transmitting related reference signals (e.g., the SRS discussed in relation to FIGS. 5A-C) from each of the plurality of antennas. In some aspects the calculation of the third calculated power may be included in the calculation of the first calculated power.

At 710, the UE may transmit, at the first calculated power, a first UL transmission carrying information related to a DL data transmission. For example, 710 may be performed by application processor(s) 906, cellular baseband processor(s) 924, transceiver(s) 922, antenna(s) 980, and/or the smart transmission component 198 of FIG. 9. The first calculated power in some aspects, may be independent of, or may be based on, the UL transmission power limit. The first calculated power, in some aspects, may be greater than, or exceed, the UL transmission power limit. Referring to FIGS. 4 and 6, for example, the UE may transmit the DL-related UL transmission associated with the first set of resources 462 and/or the first DL-related UL transmission 614 at the first calculated power.

At 712, the UE may transmit, at the second calculated power based on the indicated limit, a second UL data transmission not carrying the information related to the DL data transmission. For example, 712 may be performed by application processor(s) 906, cellular baseband processor(s) 924, transceiver(s) 922, antenna(s) 980, and/or the smart transmission component 198 of FIG. 9. Referring to FIGS. 4 and 6, for example, the UE may transmit the UL transmissions unrelated to a DL data transmission (e.g., UL data transmissions) associated with the second set of resources 464 and/or the UL transmission 618.

In some aspects, the UE may transmit, at the third calculated power that is greater than the second limit, a first UL reference signal transmission from the first antenna and a related second UL reference signal transmission from the second antenna. For example, 714 may be performed by application processor(s) 906, cellular baseband processor(s) 924, transceiver(s) 922, antenna(s) 980, and/or the smart transmission component 198 of FIG. 9. Referring to FIGS. 5A-C and 6, for example, the UE may transmit SRS 616 via the plurality of antennas 511 to 514.

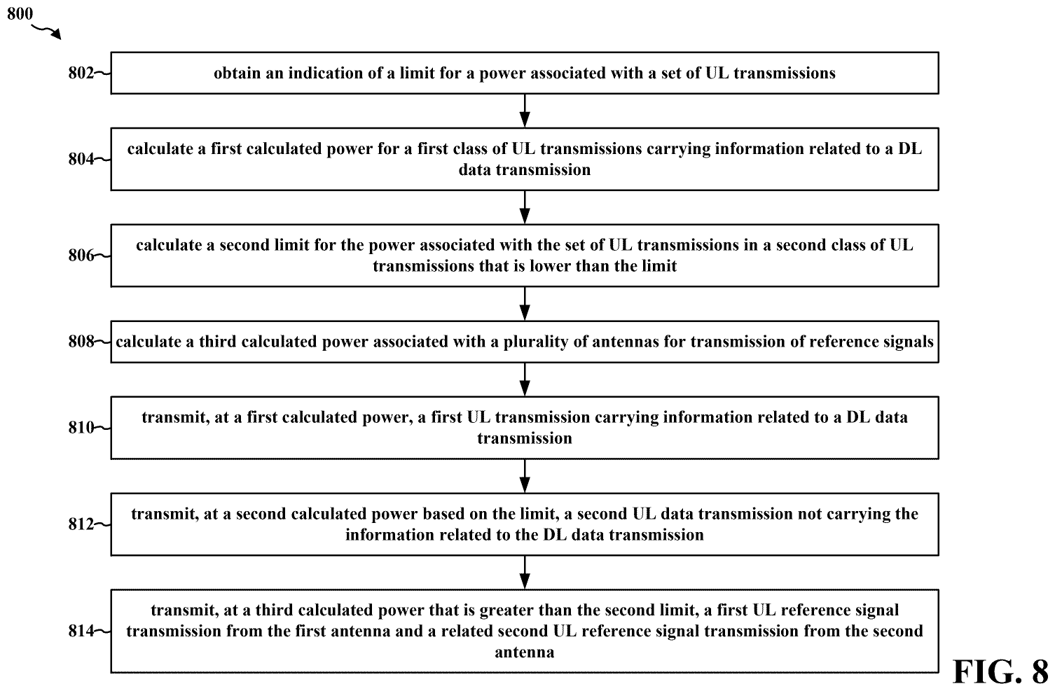

FIG. 8 is a flowchart 800 of a method of wireless communication. The method may be performed by a UE (e.g., the UE 104, 504, 604; the apparatus 904). At 802, the UE may obtain an indication of a limit for a power associated with a set of UL transmissions. In some aspects, the power associated with the set of UL transmissions may be an average power associated with a first duration. For example, 802 may be performed by application processor(s) 906, cellular baseband processor(s) 924, transceiver(s) 922, antenna(s) 980, and/or the smart transmission component 198 of FIG. 9. In some aspects, the indication may be an indication received from a base station or a known power limit based on the location and orientation of a set of antennas of the UE and a known set of limits based on additional components of the UE and/or exposure limits. The exposure limits, in some aspects, may be based on an SAR and imposed by a regulatory agency. For example, referring to FIG. 6, the UE 604 may obtain an indication of a power limit for UL transmissions at 606, that may be a known and/or configured power limit or the indication of an UL transmission power limitation 608.

At 804, the UE may calculate a first calculated power for at least a first UL transmission in a first class of UL transmissions carrying information related to a DL data transmission. In some aspects, the information related to the DL data transmission may be associated with at least one of a channel quality or a link quality. For example, 804 may be performed by application processor(s) 906, cellular baseband processor(s) 924, transceiver(s) 922, antenna(s) 980, and/or the smart transmission component 198 of FIG. 9. The first class of UL transmissions, in some aspects, may include one or more of ACKs in response to DL transmissions, NACKs in response to the DL transmissions, a RS transmission (e.g., an SRS) associated with the DL transmissions, information (e.g., CSI) regarding a channel between the UE and a source of the DL transmissions (e.g., a base station), and PUCCH transmissions. The first calculated power in some aspects, may be independent of (not based on), or may be based on, the limit obtained at 802. The first calculated power, in some aspects, may be greater than, or exceed, the UL transmission power limit indicated and/or obtained at 802. For example, referring to FIG. 6, the UE 604 may calculate, at 610, a first UL transmission power for at least a first UL transmission in a first class of UL transmissions carrying information related to a DL data transmission that may be independent of the indicated UL transmission power limit or may be based on, but greater than, the indicated UL transmission power limit.

At 806, the UE may calculate a second limit for the power associated with a set of UL transmissions (e.g., at least a second UL transmission) in a second class of UL transmissions that is lower than the indicated limit. In some aspects, the second class of UL transmissions may include UL transmissions unrelated to DL transmission performance. The first class of UL transmissions, in some aspects, may be distinct from the second class of UL transmissions. For example, 806 may be performed by application processor(s) 906, cellular baseband processor(s) 924, transceiver(s) 922, antenna(s) 980, and/or the smart transmission component 198 of FIG. 9. In some aspects, the second limit may be calculated based on a power associated with UL transmissions in the first class of UL transmissions. The second calculated power, in some aspects, may be based on the first calculated power. For example, the second calculated power may be based on an amount of power remaining before exceeding the indicated limit after the transmission of the first UL transmission at the first calculated power The first class of UL transmissions, in some aspects, may include one or more of ACKs in response to DL transmissions, NACKs in response to the DL transmissions, a RS transmission (e.g., an SRS) associated with the DL transmissions, information (e.g., CSI) regarding a channel between the UE and a source of the DL transmissions (e.g., a base station), and PUCCH transmissions. For example, referring to FIGS. 4 and 6, the UE 604 may calculate, at 610, a second UL transmission power for at least a second UL transmission in a second class of UL transmissions not carrying the information related to the DL data transmission that may be based on the indicated UL transmission power limit as described for the UL data associated with the second set of resources 464.

At 808, the UE may calculate a third calculated power associated with a plurality of antennas for transmission of reference signals. In some aspects, the UE may include a plurality of antennas and the indicated limit may include a first limit for a first power associated with a first antenna of the plurality of antennas and a second limit for a second power associated with a second antenna of the plurality of antennas. The second limit, in some aspects, may be lower than the first limit. For example, 808 may be performed by application processor(s) 906, cellular baseband processor(s) 924, transceiver(s) 922, antenna(s) 980, and/or the smart transmission component 198 of FIG. 9. The reference signals, in some aspects, may be a set of SRS configured to be transmitted at a same power from each of the plurality of antennas. For example, referring to FIGS. 5A-C and 6, the UE 604 may calculate, at 610, a third calculated power for transmitting related reference signals (e.g., the SRS discussed in relation to FIGS. 5A-C) from each of the plurality of antennas. In some aspects the calculation of the third calculated power may be included in the calculation of the first calculated power at 804.

At 810, the UE may transmit, at the first calculated power, a first UL transmission carrying information related to a DL data transmission. For example, 810 may be performed by application processor(s) 906, cellular baseband processor(s) 924, transceiver(s) 922, antenna(s) 980, and/or the smart transmission component 198 of FIG. 9. The first calculated power in some aspects, may be independent of, or may be based on, the limit obtained at 802. The first calculated power, in some aspects, may be greater than, or exceed, the UL transmission power limit indicated and/or obtained at 802. Referring to FIGS. 4 and 6, for example, the UE may transmit the DL-related UL transmission associated with the first set of resources 462 and/or the first DL-related UL transmission 614 at the first calculated power.

At 812, the UE may transmit, at the second calculated power based on the indicated limit, a second UL data transmission not carrying the information related to the DL data transmission. For example, 812 may be performed by application processor(s) 906, cellular baseband processor(s) 924, transceiver(s) 922, antenna(s) 980, and/or the smart transmission component 198 of FIG. 9. Referring to FIGS. 4 and 6, for example, the UE may transmit the UL transmissions unrelated to a DL data transmission (e.g., UL data transmissions) associated with the second set of resources 464 and/or the UL transmission 618.

At 814, the UE may transmit, at the third calculated power that is greater than the second limit, a first UL reference signal transmission from the first antenna and a related second UL reference signal transmission from the second antenna. For example, 814 may be performed by application processor(s) 906, cellular baseband processor(s) 924, transceiver(s) 922, antenna(s) 980, and/or the smart transmission component 198 of FIG. 9. Referring to FIGS. 5A-C and 6, for example, the UE may transmit SRS 616 via the plurality of antennas 511 to 514.

FIG. 9 is a diagram 900 illustrating an example of a hardware implementation for an apparatus 904. The apparatus 904 may be a UE, a component of a UE, or may implement UE functionality. In some aspects, the apparatus 904 may include at least one cellular baseband processor 924 (also referred to as a modem) coupled to one or more transceivers 922 (e.g., cellular RF transceiver). The cellular baseband processor(s) 924 may include at least one on-chip memory 924′. In some aspects, the apparatus 904 may further include one or more subscriber identity modules (SIM) cards 920 and at least one application processor 906 coupled to a secure digital (SD) card 908 and a screen 910. The application processor(s) 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize one or more antennas 980 for communication. The cellular baseband processor(s) 924 communicates through the transceiver(s) 922 via the one or more antennas 980 with the UE 104 and/or with an RU associated with a network entity 902. The cellular baseband processor(s) 924 and the application processor(s) 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor(s) 924 and the application processor(s) 906 are each responsible for general processing, including the execution of software stored on the computer-readable medium/memory. The software, when executed by the cellular baseband processor(s) 924/application processor(s) 906, causes the cellular baseband processor(s) 924/application processor(s) 906 to perform the various functions described supra. The computer-readable medium/memory may also be used for storing data that is manipulated by the cellular baseband processor(s) 924/application processor(s) 906 when executing software. The cellular baseband processor(s) 924/application processor(s) 906 may be a component of the UE 350 and may include the at least one memory 360 and/or at least one of the TX processor 368, the RX processor 356, and the controller/processor 359. In one configuration, the apparatus 904 may be at least one processor chip (modem and/or application) and include just the cellular baseband processor(s) 924 and/or the application processor(s) 906, and in another configuration, the apparatus 904 may be the entire UE (e.g., see UE 350 of FIG. 3) and include the additional modules of the apparatus 904.

As discussed supra, the smart transmission component 198 that may be configured to obtain an indication of a limit for a power associated with UL transmissions, transmit, at a first calculated power not based on the indicated limit, a first UL transmission carrying information related to a DL data transmission, and transmit, with a second calculated power based on the indicated limit, a second UL data transmission not carrying information related to the DL data transmission. The smart transmission component 198 may be within the cellular baseband processor(s) 924, the application processor(s) 906, or both the cellular baseband processor(s) 924 and the application processor(s) 906. The smart transmission component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 904 may include a variety of components configured for various functions. In one configuration, the apparatus 904, and in particular the cellular baseband processor(s) 924 and/or the application processor(s) 906, may include means for obtaining an indication of a limit for a power associated with a set of UL transmissions. The apparatus 904, and in particular the cellular baseband processor(s) 924 and/or the application processor(s) 906, may include means for transmitting, at a first calculated power, a first UL transmission carrying information related to a DL data transmission. The apparatus 904, and in particular the cellular baseband processor(s) 924 and/or the application processor(s) 906, may include means for transmitting, at a second calculated power based on the limit, a second UL data transmission not carrying the information related to the DL data transmission. The apparatus 904, and in particular the cellular baseband processor(s) 924 and/or the application processor(s) 906, may include means for calculating, based on a power associated with UL transmissions in the first class of UL transmissions, a second limit for the power associated with the set of UL transmissions in the second class of UL transmissions that is lower than the limit. The apparatus 904, and in particular the cellular baseband processor(s) 924 and/or the application processor(s) 906, may include means for transmitting, at a third calculated power that is greater than the second limit, a first UL reference signal transmission from the first antenna and a related second UL reference signal transmission from the second antenna. The apparatus 904, and in particular the cellular baseband processor(s) 924 and/or the application processor(s) 906, may include means for transmitting the first UL transmission at the first calculated power that exceeds the limit. The apparatus 904, and in particular the cellular baseband processor(s) 924 and/or the application processor(s) 906, may include means for transmitting the first UL transmission at the first calculated power that is not based on the limit. The apparatus 904 may further include means for performing any of the aspects described in connection with the flowcharts in FIGS. 7 and 8, and/or performed by the UE in the communication flow of FIG. 6. The means may be the smart transmission component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to enhancements that can be integrated to a transmission power framework taking into account the type of information sent over UL transmissions. Some aspects more specifically relate to UL transmissions that are related to DL (and/or DL control) being treated differently in order to protect DL performance in these UL transmission power limited cases. In some examples, a wireless device (e.g., a UE) may be configured to obtain an indication of a limit for a power associated with a set of UL transmissions, transmit, at a first calculated power, a first UL transmission carrying information related to a DL data transmission, and transmit, at a second calculated power based on the limit, a second UL data transmission not carrying the information related to the DL data transmission.

Particular aspects of the subject matter described in this disclosure can be implemented to realize one or more of the following potential advantages. In some examples, by treating UL transmissions that are related to DL (and/or DL control) being differently than UL transmissions unrelated to DL (and/or DL control) the described techniques can be used to protect DL performance in the presence of UL transmission power limiting.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE) comprising: obtaining an indication of a limit for a power associated with a set of uplink (UL) transmissions; transmitting, at a first calculated power, a first UL transmission carrying information related to a downlink (DL) data transmission; and transmitting, at a second calculated power based on the limit, a second UL data transmission not carrying the information related to the DL data transmission.
Aspect 2 is the method of aspect 1, wherein the power associated with the set of UL transmissions is an average power associated with a first duration.
Aspect 3 is the method of any of aspects 1 and 2, wherein the second calculated power is based on the first calculated power.
Aspect 4 is the method of aspect 3, wherein the second calculated power is based on an amount of power remaining before exceeding the limit after the transmission of the first UL transmission at the first calculated power.
Aspect 5 is the method of any of aspects 1 to 4, wherein the first UL transmission is in a first class of UL transmissions and the second UL data transmission is in a second class of UL transmissions, wherein the first class of UL transmissions is distinct from the second class of UL transmissions.
Aspect 6 is the method of aspect 5, further comprising: calculating, based on a power associated with UL transmissions in the first class of UL transmissions, a second limit for the power associated with the set of UL transmissions in the second class of UL transmissions that is lower than the limit.
Aspect 7 is the method of any of aspects 1 to 6, wherein: the first UL transmission is in a first class of UL transmissions comprising one or more of acknowledgments (ACKs) in response to DL transmissions, negative acknowledgements (NACKs) in response to the DL transmissions, a reference signal transmission associated with the DL transmissions, information regarding a channel between the UE and a source of the DL transmissions, and physical uplink control channel (PUCCH) transmissions, and the second UL data transmission is in a second class of UL transmissions comprising UL transmissions unrelated to DL transmission performance.
Aspect 8 is the method of any of aspects 1 to 7, wherein the UE comprises a plurality of antennas, wherein the limit comprises a first limit for a first power associated with a first antenna of the plurality of antennas and a second limit for a second power associated with a second antenna of the plurality of antennas, wherein the second limit is lower than the first limit.
Aspect 9 is the method of aspect 8, further comprising: transmitting, at a third calculated power that is greater than the second limit, a first UL reference signal transmission from the first antenna and a related second UL reference signal transmission from the second antenna.
Aspect 10 is the method of any of aspects 1 to 9, wherein the information related to the DL data transmission is associated with at least one of a channel quality or a link quality.
Aspect 11 is the method of any of aspects 1 to 10, wherein the first calculated power exceeds the limit, and wherein transmitting the first UL transmission at the first calculated power comprises transmitting the first UL transmission at the first calculated power that exceeds the limit.
Aspect 12 is the method of any of aspects 1 to 11, wherein the first calculated power is not based on the limit, and wherein transmitting the first UL transmission at the first calculated power comprises transmitting the first UL transmission at the first calculated power that is not based on the limit.
Aspect 13 is an apparatus for wireless communication at a device including a memory and at least one processor coupled to the memory and, based at least in part on stored information that is stored in the memory, the at least one processor is configured to implement any of aspects 1 to 12.
Aspect 14 is the apparatus of aspect 13, further including a transceiver or an antenna coupled to the at least one processor.
Aspect 15 is an apparatus for wireless communication at a device including means for implementing any of aspects 1 to 12.
Aspect 16 is a computer-readable medium (e.g., a non-transitory computer-readable medium) storing computer executable code, where the code when executed by a processor causes the processor to implement any of aspects 1 to 12.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
obtain an indication of a limit for a power associated with a set of uplink (UL) transmissions;
transmit, at a first calculated power, a first UL transmission carrying information related to a downlink (DL) data transmission; and
transmit, at a second calculated power based on the limit, a second UL data transmission not carrying the information related to the DL data transmission.

2. The apparatus of claim 1, wherein the power associated with the set of UL transmissions is an average power associated with a first duration.

3. The apparatus of claim 1, wherein the second calculated power is based on the first calculated power.

4. The apparatus of claim 3, wherein the second calculated power is based on an amount of power remaining before exceeding the limit after the transmission of the first UL transmission at the first calculated power.

5. The apparatus of claim 1, wherein the first UL transmission is in a first class of UL transmissions and the second UL data transmission is in a second class of UL transmissions, wherein the first class of UL transmissions is distinct from the second class of UL transmissions.

6. The apparatus of claim 5, wherein the at least one processor, individually or in any combination, is further configured to:
calculate, based on a power associated with UL transmissions in the first class of UL transmissions, a second limit for the power associated with the set of UL transmissions in the second class of UL transmissions that is lower than the limit.

7. The apparatus of claim 1, wherein:
the first UL transmission is in a first class of UL transmissions comprising one or more of acknowledgments (ACKs) in response to DL transmissions, negative acknowledgements (NACKs) in response to the DL transmissions, a reference signal transmission associated with the DL transmissions, information regarding a channel between the UE and a source of the DL transmissions, and physical uplink control channel (PUCCH) transmissions, and
the second UL data transmission is in a second class of UL transmissions comprising UL transmissions unrelated to DL transmission performance.

8. The apparatus of claim 1, further comprising a plurality of antennas, wherein the limit comprises a first limit for a first power associated with a first antenna of the plurality of antennas and a second limit for a second power associated with a second antenna of the plurality of antennas, wherein the second limit is lower than the first limit.

9. The apparatus of claim 8, wherein the at least one processor, individually or in any combination, is further configured to:
transmit, at a third calculated power that is greater than the second limit, a first UL reference signal transmission from the first antenna and a related second UL reference signal transmission from the second antenna.

10. The apparatus of claim 1, wherein the information related to the DL data transmission is associated with at least one of a channel quality or a link quality.

11. The apparatus of claim 1, further comprising a transceiver or an antenna coupled to the at least one processor, wherein to transmit the first UL transmission, the at least one processor, individually or in any combination, is configured to transmit the first UL transmission via the transceiver or the antenna.

12. The apparatus of claim 1, wherein the first calculated power exceeds the limit, and wherein to transmit the first UL transmission at the first calculated power, the at least one processor, individually or in any combination, is configured to transmit the first UL transmission at the first calculated power that exceeds the limit.

13. The apparatus of claim 1, wherein the first calculated power is not based on the limit, and wherein to transmit the first UL transmission at the first calculated power, the at least one processor, individually or in any combination, is configured to transmit the first UL transmission at the first calculated power that is not based on the limit.

14. A method of wireless communication at a user equipment (UE) comprising:
obtaining an indication of a limit for a power associated with a set of uplink (UL) transmissions;
transmitting, at a first calculated power, a first UL transmission carrying information related to a downlink (DL) data transmission; and
transmitting, at a second calculated power based on the limit, a second UL data transmission not carrying the information related to the DL data transmission.

15. The method of claim 14, wherein the power associated with the set of UL transmissions is an average power associated with a first duration.

16. The method of claim 14, wherein the second calculated power is based on an amount of power remaining before exceeding the limit after the transmission of the first UL transmission at the first calculated power.

17. The method of claim 14, wherein the first UL transmission is in a first class of UL transmissions and the second UL data transmission is in a second class of UL transmissions, wherein the first class of UL transmissions is distinct from the second class of UL transmissions, the method further comprising:
calculating, based on a power associated with UL transmissions in the first class of UL transmissions, a second limit for the power associated with the set of UL transmissions in the second class of UL transmissions that is lower than the limit.

18. The method of claim 14, wherein:
the first UL transmission is in a first class of UL transmissions comprising one or more of acknowledgments (ACKs) in response to DL transmissions, negative acknowledgements (NACKs) in response to the DL transmissions, a reference signal transmission associated with the DL transmissions, information regarding a channel between the UE and a source of the DL transmissions, and physical uplink control channel (PUCCH) transmissions, and
the second UL data transmission is in a second class of UL transmissions comprising UL transmissions unrelated to DL transmission performance.

19. The method of claim 14, wherein the UE comprises a plurality of antennas, wherein the limit comprises a first limit for a first power associated with a first antenna of the plurality of antennas and a second limit for a second power associated with a second antenna of the plurality of antennas, wherein the second limit is lower than the first limit, the method further comprising:
transmitting, at a third calculated power that is greater than the second limit, a first UL reference signal transmission from the first antenna and a related second UL reference signal transmission from the second antenna.

20. A computer-readable medium storing computer executable code at a user equipment (UE), the code when executed by at least one processor causes the at least one processor to:
obtain an indication of a limit for a power associated with a set of uplink (UL) transmissions;
transmit, at a first calculated power not based on the limit, a first UL transmission carrying information related to a downlink (DL) data transmission; and
transmit, at a second calculated power based on the limit, a second UL data transmission not carrying the information related to the DL data transmission.
